(19) United States
(12) Patent Application Publication
(10) Pub. No.: US 2007/0137015 A1
(43) Pub. Date: Jun. 21, 2007

(54) Diesel engine water elbow removal tool

(76) Inventor: Junior Edmonn Walker, Flatwoods, KY (US)

Correspondence Address: Junior E Walker, 86 Bug Barn Road, Flatwoods, KY, 41139, US

(21) Appl. No.: 11/300,361

(22) Filed: Dec. 15, 2005

(51) Int. Cl. B23P 19/04

(52) U.S. Cl. 29/254

(57) ABSTRACT

The invention comprises a means wherein the water elbows of locomotive engines and other large diesel engines can be removed with a slide hammer by way of attachments that can be attached to the water elbows.

### BACKGROUND OF INVENTION

Large diesel engines such as those used by the railroads for locomotives comprise multiple water elbows that transfer the coolant water from the engine block to the engine head. The elbows are installed with a vertical segment extending into the engine block with flexible o-rings located around the segment to seal the water from leaking around the elbow, the elbow having a tube-like structure on it's vertical end. The horizontal end of the elbow having a right angle comprises a flange having two bolts and an o-ring gasket, said bolts threaded into the engine head.

When an engine is operated for a long period of time without removal of these elbows, they freeze to the engine head in a recessed area where the flange bolts to the head. Sometimes it takes from forty-five (45) minutes up to four (4) hours to remove them.

This invention will show a tool for removing them in less than thirty (30) minutes, even when they are frozen or locked in place where they can't be removed without using a hammer to loosen them up, which sometimes doesn't work or without using a pry bar or some other means to remove them. The invention comprises an attachment that can be threaded into a slide hammer, which acts as a puller for the elbows. One such attachment uses the bolt holes of the flange with pins extending into the holes where the slide hammer can pull the elbow from the engine head.

### PRIOR ART

Slide hammers are used in many applications, such as bearing pullers, auto body dents, etc. They can be purchased at most auto parts stores or tool supply stores. They normally come with standard attachments. To remove the water elbows from large diesel engines such as locomotive engines, it requires a special attachment such as the one shown in this invention. The slide hammer has little value without the attachments. To my knowledge, no attachments will work on the water elbows except this special attachment of this invention.

### SUMMARY OF INVENTION

This invention comprises a diesel engine water elbow removal tool attachment that can be housed to a slide hammer. The attachment mates with segments of the water elbows and is threaded to the slide hammer.

This invention will be better understood when studied in conjunction with these drawings and written descriptions.

### BRIEF DESCRIPTIONS OF THE DRAWINGS

FIG. 1 Shows a water elbow housed to an engine.

FIG. 2 Shows a slide hammer and an attachment for said slide hammer.

FIG. 3 Is taken from line 3-2 of FIG. 1.

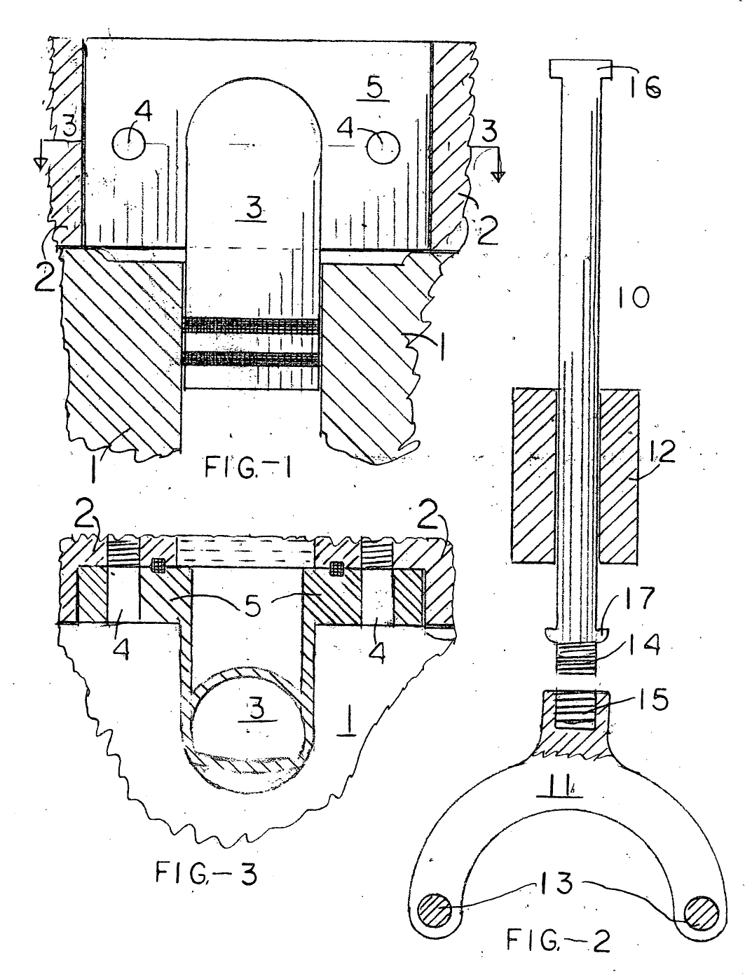

### DETAILED DESCRIPTIONS OF THE INVENTION

This invention comprises an engine block 1 and an engine head 2 having a water elbow 3 passing from the engine block 1 in a vertical position and making a right angle and passing to the engine head 2 in a horizontal position, the elbow 3 having a flange 5 that requires two bolts (not shown but is well known to those skilled in the art) that are threaded through holes 4 to the engine head 2.

An attachment 11 can be attached by way of pins 13 to holes 4. Attachment 11 comprises a threaded segment 15 that can be threaded to a slide hammer rod 10 by way of segment 14 of the slide hammer. A hammer 12 can be used to pull the elbows from the engine block 1 by attaching the pins 13 to holes 4. The slide hammer 12 is moved on a slide hammer rod 10 between stops 16 and 17 to impact against stop 16. To make the invention, the parts could be casted or fabricated from a good grade of metal, then machined to the proper tolerance, then assembled in accordance with these drawings and other descriptions.

While the preferred embodiment of the invention is shown, it should be noted that many modes of the invention might be possible without departing from the true spirit of the invention.

In operation, the attachment is threaded to the slide hammer. The bolts are removed holding flange 5. The pins 13 are then placed in holes 4. The hammer 12 is then moved hard between stop 16 and 17 on the slide hammer rod 10. The impact will pull the elbow from the engine block.

1. (canceled)

2. (canceled)

3. (canceled)

4. (canceled)

5. (canceled)

6. A tool attachment for removing the water elbows from a large diesel engine comprising: an attachment for a slide hammer, said attachment housing two fixed pins, said pins housed at a right angle to said attachment and mating with two flange bolt holes of said water elbow and having a slide hammer threaded to said attachment.

7. The invention as claimed in claim 6 is to include:
A slide hammer comprising: a slide hammer rod having a slideable hammer housed around said rod, a hammer stop at each end of said rod and a threaded end segment wherein said attachment can be housed thereto.
